(19) United States
(12) Patent Application Publication
(10) Pub. No.: US 2025/0351220 A1
(43) Pub. Date: Nov. 13, 2025

(54) SIDELINK DISCONTINUOUS RECEPTION LOGICAL SLOT SELECTION FOR SIDELINK DISCONTINUOUS RECEPTION OPERATION

(71) Applicant: Nokia Technologies Oy, Espoo (FI)

(72) Inventors: Jakob Lindbjerg BUTHLER, Aalborg (DK); Berthold PANZNER, Munich (DE)

(21) Appl. No.: 18/720,451

(22) PCT Filed: Jan. 10, 2023
(86) PCT No.: PCT/EP2023/050371

§ 371 Date: Jun. 14, 2024

Related U.S. Application Data
(60) Provisional application No. 63/299,480, filed on Jan. 14, 2022.

(51) Int. Cl. H04W 76/28; H04W 92/18

(52) U.S. Cl. CPC H04W 76/28; H04W 92/18

(57) ABSTRACT

Disclosed is a mechanism for indicating at least one sidelink resource pool applicability in terms of pre-defined sidelink discontinuous reception cycles, wherein a user equipment of a communication network, configures a sidelink configuration, wherein the sidelink configuration is selecting a best at least one sidelink resource pool of one or more sidelink resource pools and a sidelink discontinuous reception configuration compatible for sidelink operations with another user equipment which comprises at least one of a sidelink data transmission or sidelink data reception and based on the configuring, communicating towards another user equipment information comprising an indication of sidelink discontinuous reception compatibility for the sidelink operations.

### TECHNICAL FIELD

The teachings in accordance with the exemplary embodiments of this invention relate generally to a new element to indicate at least one sidelink resource pool applicability in terms of pre-defined sidelink discontinuous reception cycles and, more specifically, relate to new information element to indicate at least one sidelink resource pool applicability in terms of pre-defined sidelink discontinuous reception cycles placed in a sidelink resource pool configuration sequence definition.

### BACKGROUND

This section is intended to provide a background or context to the invention that is recited in the claims. The description herein may include concepts that could be pursued, but are not necessarily ones that have been previously conceived or pursued. Therefore, unless otherwise indicated herein, what is described in this section is not prior art to the description and claims in this application and is not admitted to be prior art by inclusion in this section.

Certain abbreviations that may be found in the description and/or in the Figures are herewith defined as follows:
DRX discontinuous reception (power saving mode)
QoS quality of service
RAN random access network
RP resource pool
RRC radio resource control
SL sidelink
UE user equipment

It is noted that there is demand for high-capacity and high-speed data processing, as well as a variety of services using and connection of wireless terminals such as in vehicles (arial or ground) or in sites, and the like. Accordingly, there is demand for technology including sidelink communications technologies for high-speed and high-capacity telecommunications systems grown out of simple voice-centric services and able to process a variety of scenarios and high-capacity data, such as wireless data, machine-type communication data, and sidelink communication data to name only a few.

With reference to sidelink communications, for a terminal device such as a user equipment sidelink transmission or reception resources may be allocated by a network device, such as allocated autonomously by sensing; a resource allocation mode 1 where a base station assigns resources to the device to device communication resource allocation mode 2, and the terminal device autonomously performs sensing and selects a resource based on this such that the terminal device may perform transmission of sidelink data according to the allocated sidelink transmission resources.

Example embodiments of this invention disclosure relates to methods and apparatus to improve sidelink related services and resource allocations in sidelink wireless communications, such as those that support discontinuous reception.

### BRIEF DESCRIPTION OF THE DRAWINGS

The above and other aspects, features, and benefits of various embodiments of the present disclosure will become more fully apparent from the following detailed description with reference to the accompanying drawings, in which like reference signs are used to designate like or equivalent elements. The drawings are illustrated for facilitating better understanding of the embodiments of the disclosure and are not necessarily drawn to scale, in which:

FIG. 1A shows four resource pool bitmaps with “x” indicating no entry;

FIG. 1B shows sidelink discontinuous reception cycles supported per resource pool (RP) for RP1 and RP2;

FIG. 2 shows a high level block diagram of various devices used in carrying out various aspects of the invention;

FIG. 3A shows a baseline functionality in accordance with example embodiments of the invention where a UE A sets up sidelink configuration with RRCReconfigurationSidelink message and a UE B responds with an RRCReconfigurationComplete message;

FIG. 3B shows FIG. 3B shows another baseline functionality in accordance with example embodiments of the invention where both the sidelink configuration transmitting user equipment and the sidelink configuration receiving user equipment are provided sidelink configuration information;

FIG. 4 shows an operational flow in accordance with example embodiments of the invention where a user equipment knows that sidelink discontinuous reception (sidelink DRX) should not be selected as no suitable pool is present;

FIG. 5 shows an operational flow in accordance with example embodiments of the invention where a resource pool does not fit well with a sidelink discontinuous reception (sidelink DRX) configuration;

FIG. 6 shows an operational flow in accordance with example embodiments of the invention where a base station such as a gNB may indicate in the pool configuration that a given pool may only be used for the indicated sidelink discontinuous reception (sidelink DRX) cycle;

FIG. 7 shows a flow chart of sidelink configuration operations in accordance with an example embodiment of the invention;

FIG. 8 shows another baseline functionality in accordance with example embodiments of the invention where a UE B may also send its own set of resource pools which is preferred for sidelink DRX operation; and

FIG. 9A and FIG. 9B each show a method in accordance with example embodiments of the invention which may be performed by an apparatus.

### DETAILED DESCRIPTION

Example embodiments of this invention relate to a new information element to indicate at least one sidelink resource pool applicability in terms of pre-defined sidelink discontinuous reception cycles placed in a sidelink resource pool configuration sequence definition.

A 3GPP work item dealing with Sidelink Enhancements at the time of this application is to look at power efficiency, primarily by following the objective to:
sidelink DRX for broadcast, groupcast, and unicast [RAN2]:
Define on- and off-durations in sidelink and specify the corresponding UE procedure;
Specify mechanism aiming to align sidelink DRX wake-up time among the UEs communicating with each other; and
Specify mechanism aiming to align sidelink DRX wake-up time with Uu DRX wake-up time in an in-coverage UE.

With the underlined part above in mind, the current discussion in RAN2 provides two general thoughts on the methods on how to align the sidelink DRX wake-up time.

Compared to Uu connection, the UE should can only transmit and receive data in a device to device manner for time periods in which sidelink resources are allocated in the given resource pool(s) (RP). Such a RP is defined as time and frequency allocation in slot-level granularity, which can be non-contiguous in the time domain. The slots allocated may be all slots non including a configured S-SSB occasion, or other reserved slots.

The slot indication is based on a (pre)configured bitmap such that it may be either a pre-configured (e.g., such as from a standards table) or a network configured bitmap, with the length of 10, 11, 12, . . . , 160, where each slot with allocated frequency resources for SL is indicated by a “1”, and each slot not containing a sidelink allocation is set to “0”. The amount of sub-channels (the granularity of a RP in frequency domain) may also be (pre)configured, but this may not be relevant for this invention.

One of the assumptions within discussions at the time of this application is in RAN2 with regards to sidelink DRX it seems to be that the sidelink connection behaves similar to Uu, which is not the full truth. One key difference, is that the sidelink resources are not necessarily defined in a continuous manner, but rather may be fractioned or split in time. This means that any given sidelink allocation from a network may either support all given DRX cycles, or not be perfectly aligned with all possible DRX cycles.

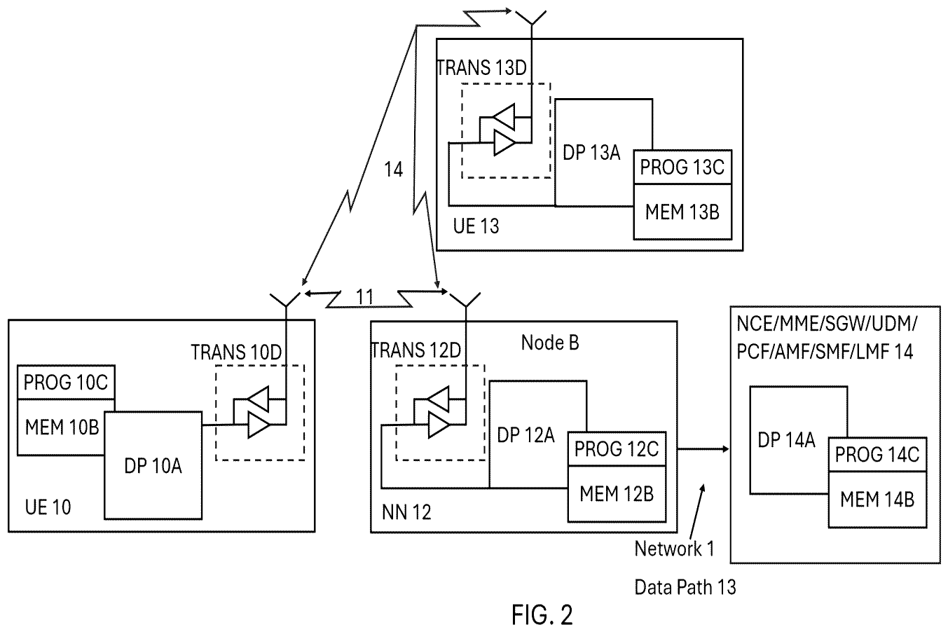

Before describing the example embodiments of the invention in detail, reference is made to FIG. 2 for illustrating a simplified block diagram of various electronic devices that are suitable for use in practicing the example embodiments of this invention.

FIG. 2 shows a block diagram of one possible and non-limiting exemplary system in which the example embodiments of the invention may be practiced. In FIG. 2, a user equipment (UE) 10 is in wireless communication with a wireless network 1 or network, 1 as in FIG. 2. The wireless network 1 or network 1 as in FIG. 2 can comprise a communication network such as a mobile network e.g., the mobile network 1 or first mobile network as disclosed herein. Any reference herein to a wireless network 1 as in FIG. 2 can be seen as a reference to any wireless network as disclosed herein. Further, the wireless network 1 as in FIG. 2 can also comprises hardwired features as may be required by a communication network. A UE is a wireless, typically mobile device that can access a wireless network. The UE, for example, may be a mobile phone (or called a “cellular” phone) and/or a computer with a mobile terminal function. For example, the UE or mobile terminal may also be a portable, pocket, handheld, computer-embedded or vehicle-mounted mobile device and performs a language signaling and/or data exchange with the RAN.

The UE 10 may comprise a user equipment or sidelink device. The UE 10 includes one or more processors DP 10A, one or more memories MEM 10B, and one or more transceivers TRANS 10D interconnected through one or more buses. Each of the one or more transceivers TRANS 10D includes a receiver and a transmitter. The one or more buses may be address, data, or control buses, and may include any interconnection mechanism, such as a series of lines on a motherboard or integrated circuit, fiber optics or other optical communication equipment, and the like. The one or more transceivers TRANS 10D which can be optionally connected to one or more antennas for communication to NN 12 and UE 13, respectively. The one or more memories MEM 10B include computer program code PROG 10C. The UE 10 communicates with NN 12 and/or UE 13 via a wireless link 11.

The UE 13 also may comprise a user equipment or sidelink device. The UE 13 includes one or more processors DP 13A, one or more memories MEM 13B, one or more network interfaces, and one or more transceivers TRANS 13D interconnected through one or more buses. In accordance with the example embodiments these network interfaces of UE 13 can include X2 and/or Xn interfaces for use to perform the example embodiments of the invention. Each of the one or more transceivers TRANS 13D includes a receiver and a transmitter that can optionally be connected to one or more antennas. The one or more memories MEM 13B include computer program code PROG 13C. For instance, the one or more memories MEM 13B and the computer program code PROG 13C are configured to cause, with the one or more processors DP 13A, the UE 13 to perform one or more of the operations as described herein. The UE 13 may communicate with another mobility function device and/or eNB such as the NN 12 and the UE 10 or any other device using, e.g., link 11 or link 14 or another link. The Link 14 as shown in FIG. 2 can be used for communication between the NN12 and the NN13. These links maybe wired or wireless or both and may implement, e.g., an X2 or Xn interface. Further, as stated above the link 11 and/or link 14 may be through other network devices such as, but not limited to an NCE/MME/SGW device such as the NCE/MME/SGW/UDM/PCF/AMF/SMF/LMF 14 of FIG. 2.

The NN 12 is a network node such as a master or secondary node base station (or a network device such as but not limited to an NR/5G Node B, an evolved NB, or LTE device for NR or LTE long term evolution) that communicates with devices such as UE 13 and UE 10 of FIG. 2, such as to configure sidelink communications between the UE. The NN 12 provides access to wireless devices such as the UE 10 and/or UE 12 to the wireless network 1. The NN 12 includes one or more processors DP 12A, one or more memories MEM 12B, and one or more transceivers TRANS 12D interconnected through one or more buses. In accordance with the example embodiments these TRANS 12D can include X2 and/or Xn interfaces for use to perform the example embodiments of the invention. Each of the one or more transceivers TRANS 12D includes a receiver and a transmitter. The one or more transceivers TRANS 12D can be optionally connected to one or more antennas for communication over at least link 11 with the UE 10. The one or more memories MEM 12B and the computer program code PROG 12C are configured to cause, with the one or more processors DP 12A, the NN 12 to perform one or more of the operations as described herein. The NN 12 may communicate with another gNB or eNB, or a device such as the UE 13 such as via link 14. Further, the link 11, link 14 and/or any other link may be wired or wireless or both and may implement, e.g., an X2 or Xn interface. Further the link 11 and/or link 14 may be through other network devices such as, but not limited to an NCE/MME/SGW/UDM/PCF/AMF/SMF/LMF 14 device as in FIG. 2. The NN 12 may perform functionalities of an MME (Mobility Management Entity) or SGW (Serving Gateway), such as a User Plane Functionality, and/or an Access Management functionality for LTE and similar functionality for 5G.

The one or more buses of the device of FIG. 2 may be address, data, or control buses, and may include any interconnection mechanism, such as a series of lines on a motherboard or integrated circuit, fiber optics or other optical communication equipment, wireless channels, and the like. For example, the one or more transceivers TRANS 12D, TRANS 13D and/or TRANS 10D may be implemented as a remote radio head (RRH), with the other elements of the NN 12 being physically in a different location from the RRH, and these devices can include one or more buses that could be implemented in part as fiber optic cable to connect the other elements of the NN 12 to an RRH.

It is noted that although FIG. 2 shows a network nodes or network devices such as NN 12, UE 10, and UE 13 whose operations can be incorporated into a centralized unit including an eNodeB or eNB or gNB such as for LTE and NR, and would still be configurable to perform example embodiments of the invention.

Also, it is noted that description herein indicates that “cells” perform functions, but it should be clear that the gNB that forms the cell and/or a user equipment and/or mobility management function device that will perform the functions. In addition, the cell makes up part of a gNB, and there can be multiple cells per gNB.

The wireless network 1 or any network it can represent may or may not include a NCE/MME/SGW/UDM/PCF/AMF/SMF/LMF 14 that may include (NCE) network control element functionality, MME (Mobility Management Entity)/SGW (Serving Gateway) functionality, and/or serving gateway (SGW), and/or MME (Mobility Management Entity) and/or SGW (Serving Gateway) functionality, and/or user data management functionality (UDM), and/or PCF (Policy Control) functionality, and/or Access and Mobility Management Function (AMF) functionality, and/or Session Management (SMF) functionality, and/or Location Management Function (LMF), and/or Authentication Server (AUSF) functionality and which provides connectivity with a further network, such as a telephone network and/or a data communications network (e.g., the Internet), and which is configured to perform any 5G and/or NR operations in addition to or instead of other standard operations at the time of this application. The NCE/MME/SGW/UDM/PCF/AMF/SMF/LMF 14 is configurable to perform operations in accordance with example embodiments of the invention in any of an LTE, NR, 5G and/or any standards based communication technologies being performed or discussed at the time of this application. In addition, it is noted that the operations in accordance with example embodiments of the invention, as performed by the NN 12 and/or UE 13, may also be performed at the NCE/MME/SGW/UDM/PCF/AMF/SMF/LMF 14.

The NCE/MME/SGW/UDM/PCF/AMF/SMF/LMF 14 includes one or more processors DP 14A, one or more memories MEM 14B, and one or more network interfaces (N/W I/F(s)), interconnected through one or more buses coupled with the link 13 and/or 14. In accordance with the example embodiments these network interfaces can include X2 and/or Xn interfaces for use to perform the example embodiments of the invention. The one or more memories MEM 14B include computer program code PROG 14C. The one or more memories MEM14B and the computer program code PROG 14C are configured to, with the one or more processors DP 14A, cause the NCE/MME/SGW/UDM/PCF/AMF/SMF/LMF 14 to perform one or more operations which may be needed to support the operations in accordance with the example embodiments of the invention.

It is noted that that the NN 12 and/or UE 13 and/or UE 10 can be configured (e.g., based on standards implementations etc.) to perform functionality of a Location Management Function (LMF). The LMF functionality may be embodied in either of the Content Consumer A, Content Consumer B, Dash Server, and/or Content Provider or may be part of these network devices or other devices associated with these devices. In addition, an LMF such as the LMF of the MME/SGW/UDM/PCF/AMF/SMF/LMF 14 of FIG. 2, as at least described below, can be co-located with UE 10 such as to be separate from the NN 12 and/or UE 13 of FIG. 2 for performing operations in accordance with example embodiments of the invention as disclosed herein.

The wireless Network 1 may implement network virtualization, which is the process of combining hardware and software network resources and network functionality into a single, software-based administrative entity, a virtual network. Network virtualization involves platform virtualization, often combined with resource virtualization. Network virtualization is categorized as either external, combining many networks, or parts of networks, into a virtual unit, or internal, providing network-like functionality to software containers on a single system. Note that the virtualized entities that result from the network virtualization are still implemented, at some level, using hardware such as processors DP10, DP12A, DP13A, and/or DP14A and memories MEM 10B, MEM 12B, MEM 13B, and/or MEM 14B, and also such virtualized entities create technical effects.

The computer readable memories MEM 12B, MEM 13B, and MEM 14B may be of any type suitable to the local technical environment and may be implemented using any suitable data storage technology, such as semiconductor based memory devices, flash memory, magnetic memory devices and systems, optical memory devices and systems, fixed memory and removable memory. The computer readable memories MEM 12B, MEM 13B, and MEM 14B may be means for performing storage functions. The processors DP10, DP12A, DP13A, and DP14A may be of any type suitable to the local technical environment, and may include one or more of general purpose computers, special purpose computers, microprocessors, digital signal processors (DSPs) and processors based on a multi-core processor architecture, as non-limiting examples. The processors DP10, DP12A, DP13A, and DP14A may be means for performing functions, such as controlling the UE 10, NN 12, UE 13, and other functions as described herein.

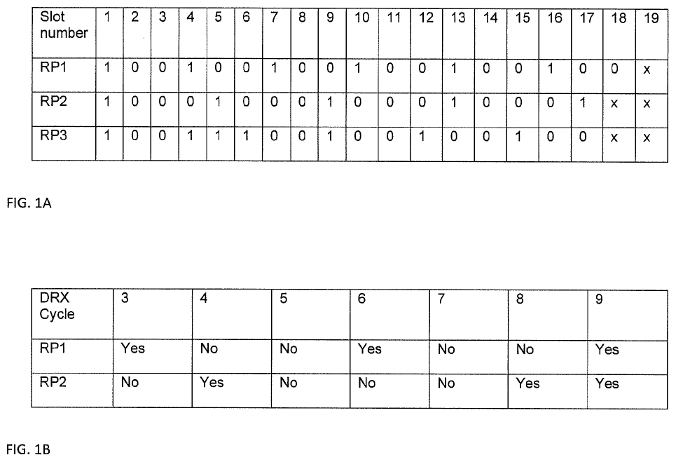

Note: that for ease of description, the examples of FIG. 1A and FIG. 1B assume that sidelink DRX cycles are defined in terms of logical slots, although in practice it may be assigned/described in time. Furthermore, to ease illustration, it can be assumed that potential slot allocation for the resources to be less than the 10 described in the introduction.

Firstly, there is a key problem with the assumption that the network sidelink resource allocation will support all defined sidelink DRX cycles, as this will limit the freedom of the networks' resource allocation significantly. As an example, if the minimum sidelink DRX cycle is defined down on a 10 slot base repetition, the network resource allocation must be able to also provide a bitmap considering every 10^{th} slot.

We see in FIG. 1A and FIG. 1B that some sidelink DRX cycles are directly supported by some RPs, whereas others are not, and some sidelink DRX cycles are supported by the same resource pools with different allocation.

Also, RP1 will be able to support the latency and/or throughput requirement of all the cycles supported by RP2, as the UE may simply use RP1's more often sidelink on-Durations as to transmit sidelink data. However, determining this by the UE for each assigned RP, or may not be trivial, and in some cases, it may lead to a UE simply often relying on choosing a sidelink DRX configuration such as RP1 rather than exploring other options.

Furthermore, for various reasons, it may be that it suits the network best to assign the sidelink resources in a less structured manner, for example as the bitmap seen for RP3, where it becomes even less trivial. By first glance, it may seem as the DRX cycle of 3 is not supported by RP3, as there between slot 3 and 10 are actually 6 slots which cannot be used. However, by further inspection there can be seen that the RP3 may actually support the latency requirements of a sidelink DRX period of 3 slots, if the sidelink transmission were made in slot 1, 4, 6, 9, 12, 15, 18, for example transmitting in a slot earlier for slot 4-6, as to align it with the actual resource allocation.

From this above analysis, the following problems can be summarized:
1. Assuming a network will support all sidelink DRX cycles will significantly limit the freedom of the network with regards to aligning the sidelink resource allocation with sidelink DRX cycle configuration, as the network needs to define the RP based on the available sidelink DRX cycles; and
2. The decision by the UE to choose the correct RP for a given sidelink DRX cycle may not be trivial:
   a. Which may lead the UE to always choose the RP with the highest resolution, causing this RP to be more congested than what it would be otherwise necessary.

The above problem is also seen in the following proposal at the time of this application, where it is also clear that this topic has not been discussed.

In another proposal the sidelink DRX timers should be calculated in the unit of physical slot, and further work to determine whether the case may happen that no sidelink slots are available in UE's active time and whether or how to solve it.

In accordance with example embodiments of this invention, there are solutions to the problems stated above.

First of all, there is a new information element to be placed for example in the sidelink resource pool configuration sequence definition, allowing the network to indicate the sidelink resource pools applicability in terms of pre-defined sidelink DRX cycles. Such information element allows not only for the UE to select the proper resource pool, but also ensures the high degree of freedom for the network to configure the RPs as is seen optimal form the network point of view.

Secondly, there is an extra layer in the calculation of the sidelink DRX-on period (sl-drx-onDurationTimer), as to accommodate for an easy alignment between UEs when calculating the next transmission or reception occasion for the given PC5link or PC5 interface in a scenario where fitting the sidelink DRX cycle to the RP may not be trivial.

Note that the wording “compatibility”, and “compliant” here indicates whether the sidelink DRX period can be supported by the RP for example RP1 in the problem statement is compliant with sidelink DRX cycle 3, 6, 9, etc.

The first embodiment comprises that: For each sidelink resource pool, one or more sidelink DRX-compatibility bits or bitmaps are indicating or can be to indicate based on the set size:
1. Single bit;
   a. whether or not all sidelink DRX (pre)configurations are supported,
2. Amount of bits equal to the number of (pre)configured sidelink DRX cycles;
   a. Bitmapped indication for the resource pools compliancy with each individual (pre)configured DRX cycle, or
3. Multiple bits, with size less than the number of (pre)configured sidelink DRX cycles:
   a. Indication of the resource pools compliancy with various levels of QoS, for example “low, medium, or high.”

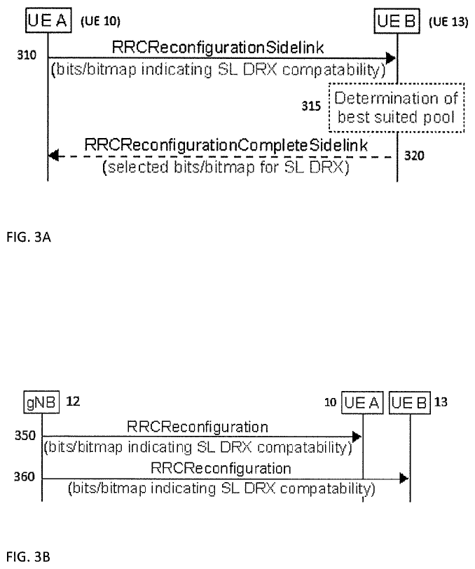

FIG. 3A shows a baseline functionality in accordance with example embodiments of the invention where at step 310 a UE A (such as the UE 10 as in FIG. 2) sets up sidelink configuration with RRCReconfigurationSidelink message towards a UE B (such as the UE 12 as in FIG. 2) and at step 315 the UE B makes a determination of best suited pool(s). Then as shown in step 320 of FIG. 3A the UE B responds with an RRCReconfigurationComplete message.

FIG. 3B shows another baseline functionality in accordance with example embodiments of the invention where both the sidelink configuration transmitting user equipment and the sidelink configuration receiving user equipment are provided sidelink configuration information. As shown in at step 350 of FIG. 3B a gNB 12 (such as the NN 12 as in FIG. 2) sends towards a UE A (such as the UE 10 as in FIG. 2) an RRCReconfiguration message with at least one bit and/or bitmap indicating sidelink DRX compatibility. Then as shown in step 360 of FIG. 3B the gNB 12 (such as the NN 12 as in FIG. 2) sends towards a UE B (such as the UE 13 as in FIG. 2) an RRCReconfiguration message with at least one bit and/or bitmap indicating sidelink DRX compatibility.

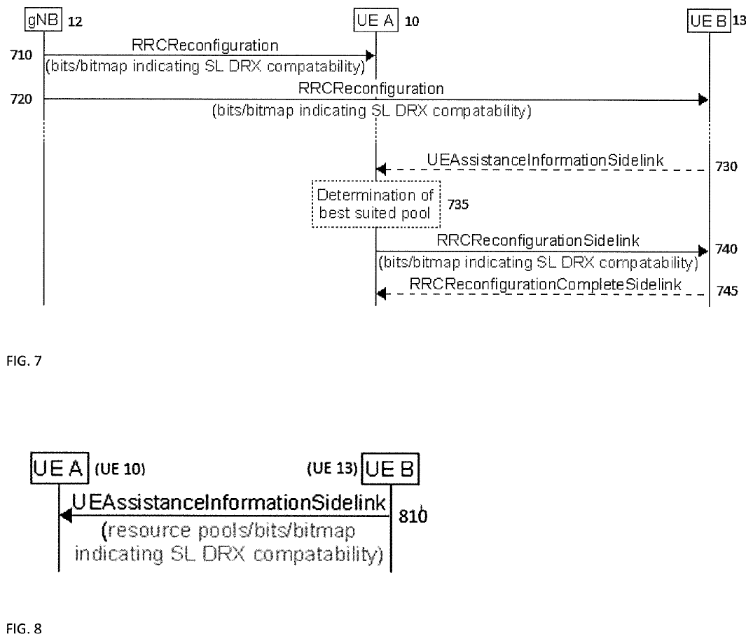

FIG. 7 shows a flow chart of sidelink configuration operations in accordance with example embodiments of the invention between a gNB 12 (such as the NN 12 as in FIG. 2), a UE A (such as the UE 10 as in FIG. 2), and a UE B (such as the UE 13 as in FIG. 2). As shown in step 710 of FIG. 7 there is the gNB 12 communicating towards the UE A 10 an RRCReconfiguration message with at least one bit and/or bitmap indicating sidelink DRX compatibility. It is noted that these operations of step 710 can be replaced with a preconfiguration at the UE A. As shown in step 720 of FIG. 7 there is communicating towards the UE B 13 an RRCReconfiguration message with at least one bit and/or bitmap indicating sidelink DRX compatibility. As shown in step 730 of FIG. 7 there is communication from the UE B 13 towards the UE A a UEAssistanceInformationSidelink message. As shown in step 735 of FIG. 7 there is determining by the UE A 10 a best suited resource pool. As shown in step 740 of FIG. 7 there is communicating from the UE A 10 towards the UE B 13 an RRCReconfiguration sidelink message with at least one bit and/or bitmap indicating sidelink DRX compatibility. Then as shown in step 745 of FIG. 7 there is communication by the UE B 13 towards the UE A 10 an RRCReconfigurationCompleteSidelink message.

An example flow can be seen in FIG. 3A as described below with the baseline functionality that the UE A sets up the sidelink configuration with RRCReconfigurationSidelink message, and the UE B responds with an RRCReconfigurationComplete message. As seen a new information element is introduced within the RRCReconfigurationSidelink, containing the above content, for example per resource pool. As an optional operation, the UE B may then use this operation to select and/or store, one or more suitable resource pools for the transmissions with a given DRX. Such operation may be especially viable when using for example a “default” DRX configuration, as this is then already known. Potentially, the UE B may reply with the selected or desired resource pool configurations, based on the DRX capability, also through a new information element, but this time in the RRCReconfigurationComplete message. As a final result the UE A and the UE B will have direct device to device communication on a sidelink, without going through network, what is named in the standards as a PC5 link or interface.

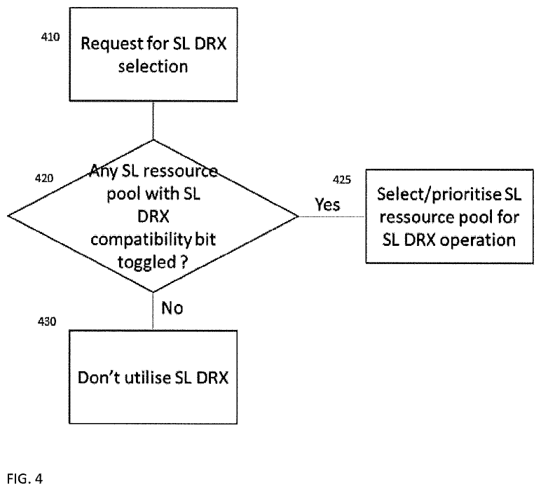

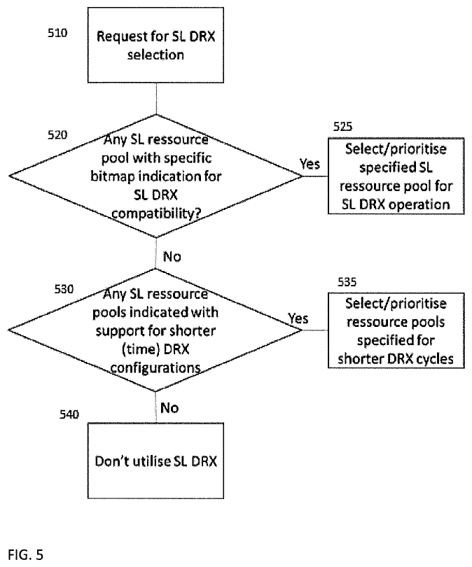

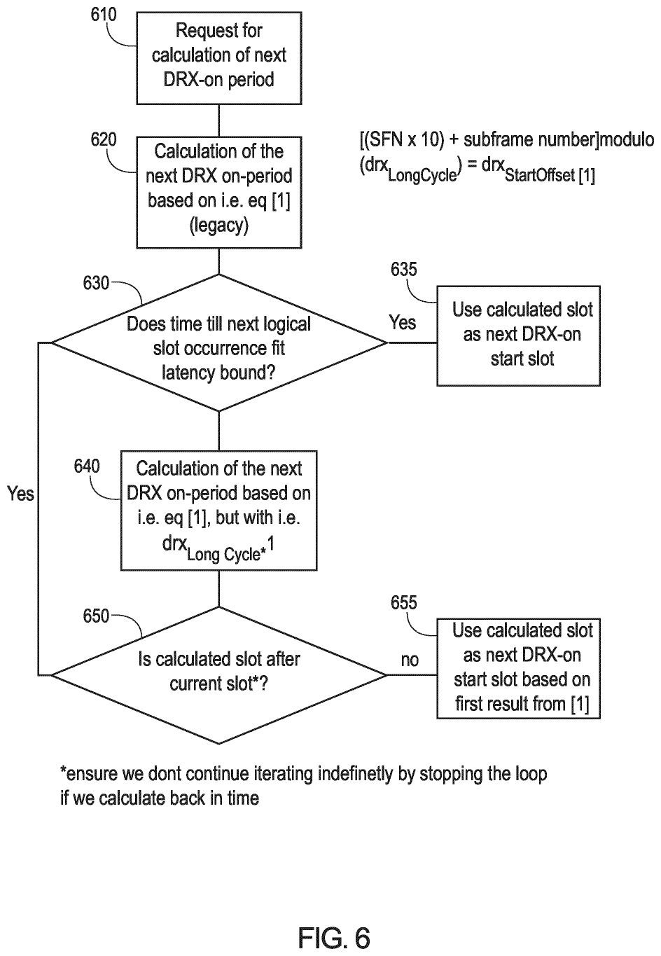

The process of determining the best suited pool may be based on flows can be seen in FIG. 4, FIG. 5, and FIG. 6. Note that the boxes may be present in different orders, and for example the “Don't utilize sidelink DRX” block may be exchanged by “select resource as legacy”, or up to UE implementation on how to behave.

FIG. 4 shows an operational flow in accordance with example embodiments of the invention where a user equipment knows that sidelink discontinuous reception (sidelink DRX) should not be selected as no suitable pool is present.

As shown in step 410 of FIG. 4 there is a request for sidelink DRX selection. Then as shown in step 420 of FIG. 4 there is a determination of any sidelink resource pool with sidelink DRX compatibility bit toggled. If the answer to step 420 is ‘yes’ then as shown in step 425 of FIG. 4 there is selecting or prioritizing a sidelink resource pool for a sidelink DRX operation. If the answer to step 420 is ‘no’ then as shown in step 430 of FIG. 4 the sidelink DRX is not utilized.

Here, the UE B/A may know that DRX should not be selected as no suitable pool is present, and the UE B/A may signal this towards the peer UE. Furthermore, the network may choose not to indicate no configured resource pools.

To extend these operations, if a resource pool does not fit well with the DRX configuration, the UE A/B may see if there is a pool more suitable to support a shorter DRX cycle, as this will increase the chance of being able to support the i.e. latency criteria although the cycle is not completely followed (related to later embodiment on calculation of DRX start period).

FIG. 5 shows an operational flow in accordance with example embodiments of the invention where a resource pool does not fit well with a discontinuous reception (DRX) configuration.

As shown in step 510 of FIG. 5 there is a request for sidelink DRX selection. Then as shown in step 520 of FIG. 5 whether there is a determination of any sidelink resource pool with specific bitmap indication for sidelink DRX compatibility. If the answer to step 520 is yes, then as shown in step 525 of FIG. 5 there is selecting or prioritizing a specified sidelink resource pool for a sidelink DRX operation. If the answer to step 520 is ‘yes’ then as shown in step 530 of FIG. 5 there is determining whether any sidelink resource pools indicated with support for shorter (time) sidelink DRX configurations. If the answer to step 530 of FIG. 5 is ‘yes’ then as shown in step 535 of FIG. 5 there is selecting or prioritizing sidelink resource pools specified for a sidelink DRX operation. If the answer to step 530 of FIG. 5 is ‘no’ then as shown in step 540 it is determined to not utilize sidelink DRX.

As an extension, the gNB may indicate in the pool configuration that a given pool may only be used for the indicated DRX cycle, and thus disabling further compatibility of for example resource pools for shorter DRX cycle.

FIG. 6 shows an operational flow in accordance with example embodiments of the invention where a base station such as a gNB may indicate in the pool configuration that a given pool may only be used for the indicated sidelink discontinuous reception (sidelink DRX) cycle

As shown in step 610 of FIG. 6 there is a request for calculation of a next DRX-on period. As shown in step 620 of FIG. 6 there is calculation of the next DRX on-period based on for example equation [1] (Legacy). As shown in step 630 of FIG. 6 there is determining whether the time till next logical slot occurrence fit is latency bound. If the answer to step 630 is ‘yes’ then as shown in step 635 of FIG. 6 there is using a calculated slot as next sidelink DRX-on slot. Also, if the answer to step 630 is ‘yes’ then as shown in step 650 of FIG. 6 there is determining if the calculated slot is after a current slot. If the answer to step 630 is ‘no’ then as shown in step 640 there is calculation of a next sidelink DRX on-period based on for example eq 1, but with for example drx_{longcycle}−1. Further, if the answer to step 650 is ‘no’ then as shown in step 655 there is using a calculated slot as next sidelink DRX-on start slot based on a first result from equation [1].

FIG. 8 shows another baseline functionality in accordance with example embodiments of the invention where a UE B (such as the UE 13 as in FIG. 2) may also send towards a UE (such as the UE 10 as in FIG. 2) its own set of resource pools which is preferred for sidelink DRX operation. As shown in step 810 of FIG. 8 the UE B sends towards the UE A a UEAssistanceInformation sidelink message. As shown in FIG. 8 the message comprises an indication of resource pools, bits, and/or bitmaps.

Alternatively, the UE B may also send its own set of resource pools which it prefers for sidelink DRX operation, as seen in FIG. 8.

The solutions as described herein may easily allow the UE to determine which resource pools is suitable for which sidelink DRX configurations. Furthermore, a network may be able to help ensure that some resource pools (for example RPs designed with many resources) are used to communicate primarily low latency, as others are deemed better off for other cycles.

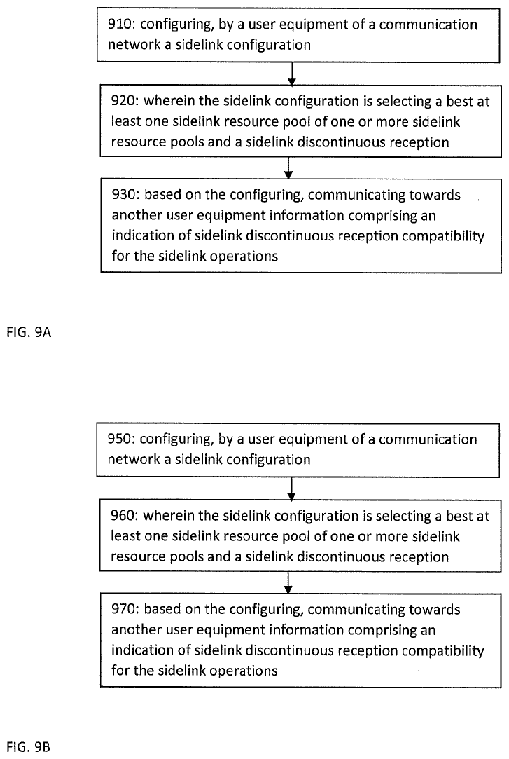

FIG. 9A and FIG. 9B each show a method in accordance with example embodiments of the invention which may be performed by an apparatus.

FIG. 9A illustrates operations which may be performed by a device such as, but not limited to, a device (e.g., the UE 10 or UE 13 as in FIG. 2). As shown in step 910 of FIG. 9A there is configuring, by a user equipment of a communication network a sidelink configuration. As shown in step 920 of FIG. 9A wherein the sidelink configuration is selecting a best at least one sidelink resource pool of one or more sidelink resource pools and a sidelink discontinuous reception configuration compatible for sidelink operations with another user equipment comprising at least one of a sidelink data transmission or sidelink data reception. Then as shown in step 930 of FIG. 9A there is, based on the configuring, communicating towards another user equipment information comprising an indication of sidelink discontinuous reception compatibility for the sidelink operations.

In accordance with the example embodiments as described in the paragraph above, wherein the configuring is based on one of: receiving from a network node of the communication network a sidelink (pre)configuration message for the configuring, making the user equipment a sidelink configuration transmitting user equipment, or receiving from the another user equipment of the communication network a sidelink configuration message for the configuring, making the user equipment a sidelink configuration receiving user equipment.

In accordance with the example embodiments as described in the paragraphs above, wherein the sidelink (pre)configuration message is a radio resource control reconfiguration message using at least one of resource pools, bits, or a bitmap to indicate sidelink discontinuous reception cycle compatibility at the user equipment.

In accordance with the example embodiments as described in the paragraphs above, wherein the configuring comprises calculating a next sidelink discontinuous reception on period.

In accordance with the example embodiments as described in the paragraphs above, wherein based upon the calculating for the next sidelink discontinuous reception on period: a single bit indicates full compliancy; or a bitmap indicates compliancy of the sidelink discontinuous reception on period for the given quality of service; or a quality of service level complies with the indication of compliant sidelink DRX period: use the next indicated slot indicated simply as i.e. T_now+sidelink DRX period; or calculate the next sidelink DRX period as the one closest to T_now+sidelink DRX period, still fulfilling a quality of service requirement.

In accordance with the example embodiments as described in the paragraphs above there is, based on the communicating, receiving from the one or more user equipment a sidelink user equipment assistance message comprising a determined or selected at least one sidelink resource pool of the one or more sidelink resource pools with a given sidelink discontinuous reception cycle for the sidelink operations.

In accordance with the example embodiments as described in the paragraphs above, wherein the sidelink UE assistance message(s) is sent from the sidelink configuration receiving user equipment to which the sidelink data reception is intended.

In accordance with the example embodiments as described in the paragraphs above there is, based on the communicating, receiving from the one or more user equipment a sidelink reconfiguration complete message comprising a determined or selected at least one sidelink resource pool of the one or more sidelink resource pools with a given sidelink discontinuous reception cycle for the sidelink operations.

In accordance with the example embodiments as described in the paragraphs above, wherein the sidelink reconfiguration complete message is using at least one of resource pools, bits, or a bitmap to indicate sidelink discontinuous reception cycle compatibility at the another user equipment based on the information.

In accordance with the example embodiments as described in the paragraphs above, wherein the sidelink reconfiguration complete message comprises an indication of a selected at least one resource pool configuration with a given discontinuous reception for transmission based on a configured discontinuous reception capability.

In accordance with the example embodiments as described in the paragraphs above, wherein the information is indicating that a given pool of the one or more sidelink resource pools may only be used for an indicated discontinuous reception cycle, thus disabling further selection of resource pools or selecting resources as legacy resources for a shorter discontinuous reception cycle.

In accordance with the example embodiments as described in the paragraphs above, wherein the legacy resources are based on legacy calculations taking into account a bitmap associated with a sidelink resource pool, a subframe number being based on a sidelink discontinuous reception cycle and sidelink start offset.

In accordance with the example embodiments as described in the paragraphs above, wherein the configuring comprises: determining by the sidelink configuration receiving user equipment a sidelink discontinuous reception on-duration based on the sidelink discontinuous reception configuration, wherein the sidelink discontinuous reception on-duration dictates that the sidelink configuration receiving user equipment should receive data on the best at least one sidelink resource pool.

In accordance with the example embodiments as described in the paragraphs above, wherein the sidelink discontinuous reception configuration is received from the sidelink configuration transmitting user equipment.

In accordance with the example embodiments as described in the paragraphs above, wherein the sidelink discontinuous reception configuration is received from the network node.

In accordance with the example embodiments as described in the paragraphs above, wherein calculating a next sidelink discontinuous reception on-duration comprises at least one of: statically: calculating next sidelink DRX on-Period as in equation; and if the latency bound fulfils the latency required for the given QoS: i. use the logical slot as calculated; or else ii. use the logical slot before the calculated logical slot; or iteratively: calculating next slot for the sidelink discontinuous reception on-duration as in equation; if the latency bound fulfils the latency required for the given QOS: ii. Use the logical slot as calculated; ii. or else while the latency bound cannot be fulfilled by the selected slot: calculate the next slot as current slot minus 1.

In accordance with the example embodiments as described in the paragraphs above, wherein the sidelink discontinuous reception configuration comprises a given discontinuous reception of the at least one given discontinuous reception should not be selected based on no suitable resource pool of at least one resource pool is present.

In accordance with the example embodiments as described in the paragraphs above, wherein the sidelink discontinuous reception configuration is using an information element for enabling at the user equipment determination of a preferred resource block for the sidelink operations.

In accordance with the example embodiments as described in the paragraphs above, wherein the sidelink discontinuous reception configuration comprises an indication of at least one preferred resource pool in which the sidelink operations should be performed.

A non-transitory computer-readable medium (MEM 10B and/or MEM 13B as in FIG. 2) storing program code (PROG 10C and/or PROG 13C as in FIG. 2), the program code executed by at least one processor (DP 10A and/or DP 13A as in FIG. 2) to perform the operations as at least described in the paragraphs above.

In accordance with an example embodiment of the invention as described above there is an apparatus comprising: means for configuring (TRANS 10d and/or TRANS 13d; MEM 10B and/or MEM 13B; PROG 10C and/or PROG 13C; and DP 10A and/or DP 13A as in FIG. 2), by a user equipment (UE 10 and/or UE 13 as in FIG. 2) of a communication network (Network 1 as in FIG. 2) a sidelink configuration, wherein the sidelink configuration is selecting (TRANS 10d and/or TRANS 13d; MEM 10B and/or MEM 13B; PROG 10C and/or PROG 13C; and DP 10A and/or DP 13A as in FIG. 2) a best at least one sidelink resource pool of one or more sidelink resource pools and a sidelink discontinuous reception configuration compatible for sidelink operations with another user equipment comprising at least one of a sidelink data transmission or sidelink data reception; and means, based on the configuring, for communicating (TRANS 10d and/or TRANS 13d; MEM 10B and/or MEM 13B; PROG 10C and/or PROG 13C; and DP 10A and/or DP 13A as in FIG. 2) towards another user equipment (UE 10 or UE 13 as in FIG. 2) information comprising an indication of sidelink discontinuous reception compatibility for the sidelink operations.

In the example aspect of the invention according to the paragraph above, wherein at least the means for configuring, selecting, and communicating comprises a non-transitory computer readable medium [MEM 10B and/or MEM 13B] encoded with a computer program [PROG 10C and/or PROG 13C] executable by at least one processor [DP 10A and/or DP 13A].

FIG. 9B illustrates operations which may be performed by a network device such as, but not limited to, a network node NN 12 as in FIG. 2 or an eNB. As shown in step 950 of FIG. 9B there is determining, by a network node of a communication network a sidelink configuration; as shown in step 960 of FIG. 9B wherein the sidelink configuration contains at least one sidelink resource pool of one or more sidelink resource pools and at least one indication for sidelink discontinuous reception configuration for sidelink operations with a user equipment comprising at least one of a sidelink data transmission or sidelink data reception. Then as shown in step 970 of FIG. 9B there is, based on the determining, communicating towards the user equipment information comprising an indication of a sidelink configuration message for sidelink discontinuous reception compatibility at the user equipment.

In accordance with the example embodiments as described in the paragraph above, wherein the information comprises an indication of sidelink discontinuous reception operation cycle availability of one or more sidelink resource pools for use at the user equipment for sidelink operations comprising at least one of a sidelink transmission or reception; and

In accordance with the example embodiments as described in the paragraphs above, wherein the indication comprises one or more sidelink discontinuous reception compatibility bits or bitmaps each associated with a resource pool of the one or more sidelink resource pools with at least one given discontinuous reception.

In accordance with the example embodiments as described in the paragraphs above, wherein the one or more sidelink discontinuous reception compatibility bits or bitmaps are superseded by an indication of the information being a network preference or suggestion.

In accordance with the example embodiments as described in the paragraphs above, wherein the one or more sidelink discontinuous reception compatibility bits or bitmaps are indicated based on a set size of each of the one or more sidelink discontinuous reception compatibility bits or bitmaps.

In accordance with the example embodiments as described in the paragraphs above, wherein the set size comprises a single bit indicating whether or not all sidelink discontinuous reception configurations are supported.

In accordance with the example embodiments as described in the paragraphs above, wherein the set size comprises an amount of sidelink discontinuous reception compatibility bits equal to a number of sidelink discontinuous reception cycles, wherein the indication comprises a bitmapped indication for resource pool compliancy with each of the number of sidelink discontinuous reception cycles.

In accordance with the example embodiments as described in the paragraphs above, wherein the set size comprises multiple bits with a size less than a number of sidelink discontinuous reception cycles, wherein the indication comprises an indication of resource pool compliancy with various quality of service levels.

In accordance with the example embodiments as described in the paragraphs above, wherein the information is indicating that a given pool of the one or more sidelink resource pools may only be used for an indicated discontinuous reception cycle, thus disabling further selection of resource pools or selecting resources as legacy resources for a shorter discontinuous reception cycle.

In accordance with the example embodiments as described in the paragraphs above, wherein the legacy resources are based on legacy calculations taking into account a bitmap associated with a sidelink resource pool, a subframe number being based on a sidelink discontinuous reception cycle and sidelink start offset.

A non-transitory computer-readable medium (MEM 12B as in FIG. 2) storing program code (PROG 12C as in FIG. 2), the program code executed by at least one processor (DP 12A as in FIG. 2) to perform the operations as at least described in the paragraphs above.

In accordance with an example embodiment of the invention as described above there is an apparatus comprising: means for determining (TRANS 12D; MEM 12B; PROG 12C; and DP 12A as in FIG. 2), by a network node (NN 12 as in FIG. 2) of a communication network (Network 1 as in FIG. 2) a sidelink configuration, wherein the sidelink configuration contains at least one sidelink resource pool of one or more sidelink resource pools and at least one indication (TRANS 12D; MEM 12B; PROG 12C; and DP 12A as in FIG. 2) for sidelink discontinuous reception configuration for sidelink operations with a user equipment (UE 10 and/or UE 13 as in FIG. 2) comprising at least one of a sidelink data transmission or sidelink data reception; and means, based on the determining, communicating (TRANS 12D; MEM 12B; PROG 12C; and DP 12A as in FIG. 2) towards the user equipment information comprising an indication of a sidelink configuration message for sidelink discontinuous reception compatibility at the user equipment.

In the example aspect of the invention according to the paragraph above, wherein at least the means for determining, indicating, and communicating comprises a non-transitory computer readable medium [MEM 1B] encoded with a computer program [PROG 12C] executable by at least one processor [DP 12A].

In another embodiment, the bits indicating the sidelink DRX compatibility with the RP(s) may even be superseded by an indication of whether this is network preference or suggestion, or whether it is a dedicated rule for the UE to follow.

In still another embodiment, there is upon calculating the next sidelink DRX-ON period, the UE may check the sidelink DRX-compatibility bit(s), and if:
1. The single bit indicates full compliancy; or
2. The bitmap indicates compliancy of the sidelink DRX period for the given QoS/PQI/PFI/etc.; or
3. The QoS level for example complies with the indication of compliant sidelink DRX period:
   a. Use the next indicated slot indicated simply as for example T_now+sidelink DRX period; or
4. Else:
   a. Calculate the next sidelink DRX period as the one closest to T_now+sidelink DRX period, still fulfilling the QoS requirement.

In another embodiment, the UE may provide in the sidelink RRC configuration of for example a sidelink unicast link which of the methods in 6.1 or 6.2 is to be used. In the current design of sidelink DRX, it may be agreed that the unicast UE is able to configure the sidelink DRX cycle through sidelink RRC, and here there is included an extra information element in this type of configuration determining for example the method of calculation, or even preferred resource block.

In another embodiment, there is included in the UE assistance information the preferred RP(s) in which the communication should be located. This would allow the UE providing assistance information to for example request a sidelink DRX configuration in RP1 of the problem statement, even though RP2 would also be possible. This would be beneficial for the UE providing the assistance information if that already had a communication link established requiring the low latency of RP1, but the UE establishing the new link only requiring latency which can be supported by RP2.

### Calculation of Next Sidelink DRX Cycle for Compliant Cases

For compliant cases, legacy calculation should be used, taking into account the bitmap of the sidelink resource pool, for example as the subframe number as being based on the sidelink DRX cycle and sidelink start offset only.

[(SFN×10)+subframe number] modulo (drx_{LongCycle})=drx_{StartOffset} as in equation [1].

Although the naming of the sidelink timers may differ from this, it will also include the assigned slot numbers in the calculation. An important factor of this calculation is the simplicity of calculating in a compliant matter.

### Calculation of Next Sidelink DRX Cycle for Non-Compliant Cases

Calculating the next sidelink DRX cycle for the non-compliant cases may be done either statically, or iteratively:
1. Statically;
   a. Calculate next sidelink DRX on-Period as in equation [1];
   b. If the latency bound fulfils the latency required for the given QoS;
      i. Use the logical slot as calculated
   c. Else;
      i. Use the logical slot before the calculated logical slot; or
2. Iteratively;
   a. Calculate next slot for the sidelink DRX on-Period as in equation [1];
   b. If the latency bound fulfils the latency required for the given QoS;
      i. Use the logical slot as calculated; or
   c. Else:
      i. While the latency bound cannot be fulfilled by the selected slot;
         1. Calculate the next slot as current slot minus 1.

In accordance with example embodiments of the invention as disclosed in this application this application, the “circuitry” provided can include at least one or more or all of the following:
(a) hardware-only circuit implementations (such as implementations in only analog and/or digital circuitry);
(b) combinations of hardware circuits and software, such as (as applicable):
   (i) a combination of analog and/or digital hardware circuit(s) with software/firmware; and
   (ii) any portions of hardware processor(s) with software (including digital signal processor(s)), software, and memory(ies) that work together to cause an apparatus, such as a mobile phone or server, to perform various functions, such as functions or operations in accordance with example embodiments of the invention as disclosed herein); and
(c) hardware circuit(s) and or processor(s), such as a microprocessor(s) or a portion of a microprocessor(s), that requires software (e.g., firmware) for operation, but the software may not be present when it is not needed for operation.”

In accordance with example embodiments of the invention, there is adequate circuitry for performing at least novel operations as disclosed in this application, this ‘circuitry’ as may be used herein refers to at least the following:
(a) hardware-only circuit implementations (such as implementations in only analog and/or digital circuitry); and
(b) to combinations of circuits and software (and/or firmware), such as (as applicable): (i) to a combination of processor(s) or (ii) to portions of processor(s)/software (including digital signal processor(s)), software, and memory(ies) that work together to cause an apparatus, such as a mobile phone or server, to perform various functions); and
(c) to circuits, such as a microprocessor(s) or a portion of a microprocessor(s), that require software or firmware for operation, even if the software or firmware is not physically present.

This definition of ‘circuitry’ applies to all uses of this term in this application, including in any claims. As a further example, as used in this application, the term “circuitry” would also cover an implementation of merely a processor (or multiple processors) or portion of a processor and its (or their) accompanying software and/or firmware. The term “circuitry” would also cover, for example and if applicable to the particular claim element, a baseband integrated circuit or applications processor integrated circuit for a mobile phone or a similar integrated circuit in a server, a cellular network device, or other network device.

In general, the various embodiments may be implemented in hardware or special purpose circuits, software, logic or any combination thereof. For example, some aspects may be implemented in hardware, while other aspects may be implemented in firmware or software which may be executed by a controller, microprocessor or other computing device, although example embodiments of this invention are not limited thereto. While various aspects of example embodiments of this invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

Embodiments of the inventions may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

The word “exemplary” is used herein to mean “serving as an example, instance, or illustration.” Any embodiment described herein as “exemplary” is not necessarily to be construed as preferred or advantageous over other embodiments. All of the embodiments described in this Detailed Description are exemplary embodiments provided to enable persons skilled in the art to make or use example embodiments of this invention and not to limit the scope of the invention which is defined by the claims.

The foregoing description has provided by way of exemplary and non-limiting examples a full and informative description of the best method and apparatus presently contemplated by the inventors for carrying out the invention. However, various modifications and adaptations may become apparent to those skilled in the relevant arts in view of the foregoing description, when read in conjunction with the accompanying drawings and the appended claims. However, all such and similar modifications of the teachings of this invention will still fall within the scope of this invention.

It should be noted that the terms “connected,” “coupled,” or any variant thereof, mean any connection or coupling, either direct or indirect, between two or more elements, and may encompass the presence of one or more intermediate elements between two elements that are “connected” or “coupled” together. The coupling or connection between the elements can be physical, logical, or a combination thereof. As employed herein two elements may be considered to be “connected” or “coupled” together by the use of one or more wires, cables and/or printed electrical connections, as well as by the use of electromagnetic energy, such as electromagnetic energy having wavelengths in the radio frequency region, the microwave region and the optical (both visible and invisible) region, as several non-limiting and non-exhaustive examples.

Furthermore, some of the features of the preferred embodiments of this invention could be used to advantage without the corresponding use of other features. As such, the foregoing description should be considered as merely illustrative of the principles of the invention, and not in limitation thereof.

1-23. (canceled)

24. A method, comprising:
configuring, by a user equipment of a communication network, a sidelink configuration,
wherein the sidelink configuration is selecting a best at least one sidelink resource pool of one or more sidelink resource pools and a sidelink discontinuous reception configuration compatible for sidelink operations with another user equipment comprising at least one of a sidelink data transmission or sidelink data reception; and
based on the configuring, communicating towards another user equipment information comprising an indication of sidelink discontinuous reception compatibility for the sidelink operations.

25. An apparatus comprising:
at least one processor; and at least one memory, the at least one memory storing instructions, that when executed by the at least one processor, cause the apparatus to:
configure, by a user equipment of a communication network, a sidelink configuration,
wherein the sidelink configuring selects a best at least one sidelink resource pool of one or more sidelink resource pools and a sidelink discontinuous reception configuration compatible for sidelink operations with another user equipment comprising at least one of a sidelink data transmission or sidelink data reception; and
based on the configuring, communicating towards another user equipment information comprising an indication of sidelink discontinuous reception compatibility for the sidelink operations.

26. The apparatus of claim 25, wherein the at least one processor; and the at least one memory, the at least one memory storing instructions, that when executed by the at least one processor, further cause the apparatus to at least configure based on one of:
receiving from a network node of the communication network a sidelink (pre)configuration message for the configuring, making the user equipment a sidelink configuration transmitting user equipment, or
receiving from the another user equipment of the communication network a sidelink configuration message for the configuring, making the user equipment a sidelink configuration receiving user equipment.

27. The apparatus of claim 26, wherein the sidelink (pre)configuration message is a radio resource control reconfiguration message using at least one of resource pools, bits, or a bitmap to indicate sidelink discontinuous reception cycle compatibility at the user equipment.

28. The apparatus of claim 25, wherein the at least one processor; and the at least one memory, the at least one memory storing instructions, that when executed by the at least one processor, further cause the apparatus to calculate a next sidelink discontinuous reception on period.

29. The apparatus of claim 28, wherein based upon the calculating for the next sidelink discontinuous reception on period:
a single bit indicates full compliancy; or
a bitmap indicates compliancy of the sidelink discontinuous reception on period for the given quality of service; or
a quality of service level complies with the indication of compliant sidelink DRX period,
the at least one processor; and the at least one non-transitory memory including computer program code, are configured, to further cause the apparatus to use the next indicated slot indicated simply as a T_now+sidelink DRX period or to calculate the next sidelink DRX period as the one closest to T_now+sidelink DRX period, still fulfilling a quality of service requirement.

30. The apparatus of claim 25, wherein the at least one processor; and the at least one memory, the at least one memory storing instructions, that when executed by the at least one processor, further cause the apparatus to, based on the communicating, receive from the one or more user equipment a sidelink user equipment assistance message comprising a determined or selected at least one sidelink resource pool of the one or more sidelink resource pools with a given sidelink discontinuous reception cycle for the sidelink operations.

31. The apparatus of claim 30, wherein the sidelink user equipment assistance message(s) is sent from the sidelink configuration receiving user equipment to which the sidelink data reception is intended.

32. The apparatus of claim 25, wherein the at least one processor; and the at least one memory, the at least one memory storing instructions, that when executed by the at least one processor, further cause the apparatus to, based on the communicating, receive from the one or more user equipment a sidelink reconfiguration complete message comprising a determined or selected at least one sidelink resource pool of the one or more sidelink resource pools with a given sidelink discontinuous reception cycle for the sidelink operations.

33. The apparatus of claim 25, wherein the at least one processor; and the at least one memory, the at least one memory storing instructions, that when executed by the at least one processor, further cause the apparatus to:
determine by the sidelink configuration receiving user equipment a sidelink discontinuous reception on-duration based on the sidelink discontinuous reception configuration,
wherein the sidelink discontinuous reception on-duration dictates that the sidelink configuration receiving user equipment should receive data on the best at least one sidelink resource pool.

34. The apparatus of claim 25, wherein the sidelink discontinuous reception configuration comprises a given discontinuous reception of the at least one given discontinuous reception should not be selected based on no suitable resource pool of at least one resource pool is present.

35. The apparatus of claim 25, wherein the sidelink discontinuous reception configuration uses an information element for enabling at the user equipment determination of a preferred resource block for the sidelink operations.

36. The apparatus of claim 25, wherein the sidelink discontinuous reception configuration comprises an indication of at least one preferred resource pool in which the sidelink operations should be performed.

37. An apparatus comprising:
at least one processor; and at least one memory, the at least one memory storing instructions, that when executed by the at least one processor, cause the first apparatus to at least:
determine, by a network node of a communication network a sidelink configuration,
wherein the sidelink configuration contains at least one sidelink resource pool of one or more sidelink resource pools and at least one indication for sidelink discontinuous reception configuration for sidelink operations with a user equipment comprising at least one of a sidelink data transmission or sidelink data reception; and
based on the determining, communicate towards the user equipment information comprising an indication of a sidelink configuration message for sidelink discontinuous reception compatibility at the user equipment.

38. The apparatus of claim 37, wherein the information comprises an indication of sidelink discontinuous reception operation cycle availability of one or more sidelink resource pools for use at the user equipment for sidelink operations comprising at least one of a sidelink transmission or reception.

39. The apparatus of claim 37, wherein the indication comprises one or more sidelink discontinuous reception compatibility bits or bitmaps each associated with a resource pool of the one or more sidelink resource pools with at least one given discontinuous reception.

40. The apparatus of claim 39, wherein the one or more sidelink discontinuous reception compatibility bits or bitmaps are superseded by an indication of the information being a network preference or suggestion.

41. The apparatus of claim 39, wherein the indication indicates that a given pool of the one or more sidelink resource pools may only be used for an indicated discontinuous reception cycle, thus disabling further selection of resource pools or selecting resources as legacy resources for a shorter discontinuous reception cycle.

42. The apparatus of claim 41, wherein the legacy resources are based on legacy calculations taking into account a bitmap associated with a sidelink resource pool, a subframe number being based on a sidelink discontinuous reception cycle and sidelink start offset.
